(19) United States
(12) Patent Application Publication
(10) Pub. No.: US 2021/0364127 A1
(43) Pub. Date: Nov. 25, 2021

(54) RESERVOIR MADE OF COMPOSITE MATERIAL FOR CONTAINING A PRESSURE FLUID

(71) Applicant: Gilles ROCHER, Le Mont-sur-Lausanne (CH)

(72) Inventor: Gilles ROCHER, Le Mont-sur-Lausanne (CH)

(21) Appl. No.: 17/385,426

(22) Filed: Jul. 26, 2021

Related U.S. Application Data
(62) Division of application No. 16/302,198, filed on Nov. 16, 2018.

(30) Foreign Application Priority Data
May 19, 2016 (EP) 16170389.7

(51) Int. Cl. F17C 1/16; F17C 1/00

(52) U.S. Cl. CPC F17C 1/16; F17C 2203/0624; F17C 2201/0109; F17C 2201/054; F17C 2201/056; F17C 2203/013; F17C 2203/0604; F17C 2203/0621; F17C 2203/0665; F17C 2203/0668; F17C 2203/0673; F17C 2205/0305; F17C 2205/0332; F17C 2205/0397; F17C 2209/2118; F17C 2209/2163; F17C 2209/221; F17C 2209/236; F17C 2223/0123; F17C 2223/036; F17C 2260/012; F17C 2260/013; F17C 2209/22; F17C 2209/234; F17C 1/00

(57) ABSTRACT

A method for forming a reservoir made of a composite material includes a tubular element, two end fittings, each inserted into one end of the tubular element, and a circumferential layer that envelops the tubular element and the end fittings. The circumferential layer is made of resin-impregnated wound fibers. At least one segment of each end fitting has an outwardly tapering shape and the wall has a taper at each end, and thus at each end the wall is pressed against the segment surface having a tapering shape. The tubular element includes a plastic tube surrounded by a longitudinal layer essentially made of parallel fibers in a resin matrix, the parallel fibers being oriented along the longitudinal axis of the plastic tube. The circumferential layer is essentially made of fibers wound around the circumference of the tubular element and end fittings and parallel to each other.

### CROSS-REFERENCE TO RELATED APPLICATION

This application is a divisional of U.S. patent application Ser. No. 16/302,198 filed on Nov. 16, 2018, which is the national phase of PCT International Application No. PCT/IB2017/052928 filed on May 18, 2017, which claims priority to EP Patent Application No. 16170389.7 filed on May 19, 2016, the contents of which are hereby incorporated by reference.

### FIELD OF THE INVENTION

The present invention relates to a container made of composite material to contain a pressurised fluid, the container comprising a tubular member, an axial tip inserted into one end of the tubular member, and a circumferential layer formed of resin-saturated fibres, the circumferential layer surrounding the tubular member and the axial tip. A section at least of the axial tip has a shape which tapers towards the outside, and the end of the wall of the tubular member has a narrowing such that it comes to be placed against the surface of the tapered section. The present invention likewise relates to a method for producing a container made of composite material in accordance with the above definition.

PRIOR ART

Containers made of composite material are already known. Patent document FR 2 923 575 in particular describes a container for containing a pressurised fluid which corresponds to the definition provided in the preamble. In this known container, the tubular member is formed by a polyamide 6 cylinder and the two tips which are inserted into the ends of the tubular member are formed of an aluminium alloy. In a conventional manner, at least one of the two tips is provided with an input/output interface comprising a valve. The above-mentioned document teaches that, during manufacturing of the container, a narrowing of the wall of the polyamide cylinder is produced at each of its ends using a flow forming process. The ends of the tubular member can thus be shaped on the two tips.

According to the above-mentioned document, the structural layer is then produced by simultaneously winding two strips each comprising a large number of thermosetting resin-impregnated fibres. The two strips are helically wound around the tubular member, substantially symmetrical to the axis of the tubular member. Generally, the production of a structural layer of the shell of a container, using the helicoidal winding technique described in the above-mentioned patent document, has some disadvantages.

Firstly, all of the fibres of the helicoidal layers necessary to hold the tips pass via the cylindrical part of the container which becomes oversized as a result. Moreover, the accumulation of fibres in the region of the tips contributes to more material being used than would be strictly necessary from a structural point of view.

Secondly, it is common to build up the superposed helicoidal winding layers by beginning with the layers with an orientation which deviates least from the axial direction of the container, so as to effectively hold the tips and prevent their ejection under the effect of the pressure of the compressed fluid in the container. Owing to the multiplication of the winding layers, the helicoidal winding process involves a very high number of fibre crossings which thus make a structure similar to that of a woven fabric where the fibres are not straight but undulate by passing above and below other fibres. However, it is known when using composite materials that a woven structure is less effective, in particular in tension, than a unidirectional or multiaxial structure in which the fibres do not undulate. An implementation process without the fibres crossing and thus without them undulating would allow the performance potential of the reinforcing fibres to be better optimised.

Thirdly, the filament-winding process, although it can be automated and is relatively quick for containers with small dimensions, becomes very ineffective for very long containers because the winding machine takes a lot of time passing back and forth to coil the fibres around the tips for a very small amount of coiled material per unit of time. A continuous or semi-continuous process allowing the necessary amount of fibres and resin to be placed in a single pass or in a limited number of passes would represent a considerable gain in productivity.

On the other hand, according to patent document FR 2 923 575, the resin used to act as a matrix for the fibres of the structural layer is a thermosetting resin. The type of thermosetting resin most commonly used for producing containers is epoxy resin, but epoxy resin requires extreme care during its transport, storage and preparation and also in its curing cycle in order to obtain the expected performances. Moreover, thermosetting resins cannot be recycled. It would be advantageous from the point of view of implementation and of recyclability to use a resin from the family of thermoplastics. However, thermoplastic resins must be heated above their melting temperature in order to be rendered more fluid and to facilitate their use and the impregnation of the fibres. Nevertheless, they often remain more viscous than epoxy resins and often generate greater porosity in the composite structure.

### BRIEF DESCRIPTION OF THE INVENTION

One aim of the present invention is to overcome the disadvantages of the prior art which were described above. In accordance with a first aspect of the invention, the invention achieves its aim by providing a container made of composite material as claimed in the appended claim 1. In accordance with a second aspect of the invention, the invention achieves its aim by providing a method for producing a container made of composite material as claimed in the appended claim 10.

In the present description, the expression “longitudinal fibres” refers to fibres which are oriented in parallel with the axis of the tubular member, and the expression “circumferential fibres” refers to fibres with a path formed of a series of turns, each turn extending in a plane substantially perpendicular to the axis of the tubular member.

It will be understood that, in accordance with the invention, the fibres of the longitudinal layer of the tubular member all have the same longitudinal orientation. Moreover, the fibres of the circumferential layer all have the same circumferential orientation. One advantage of the invention is thus that it allows the use of only the amount of fibres strictly necessary to allow the container to resist the pressure of the fluid contained therein. This results in a substantial saving in material.

It will also be understood that since the fibres of a single layer are oriented in parallel, the container of the invention is able to be produced without the fibres crossing and thus without them undulating. One advantage of this feature is that it allows the performance potential of the reinforcing fibres to be exploited in a more optimised manner.

In accordance with an advantageous embodiment of the invention, the resins which impregnate the fibres of the circumferential layer and the fibres of the longitudinal layer of the tubular member are thermoplastic resins. In fact, it will be understood that the absence of crossing fibres in the container of the invention allows the use of thermoplastic resins whilst limiting the risk of fine porosity.

### BRIEF DESCRIPTION OF THE FIGURES

Other features and advantages of the present invention will become clear upon reading the following description given solely by way of non-limiting example, and given with reference to the attached drawings in which:

FIG. 1A is a transverse cross-sectional view of a container made of composite material in accordance with a first embodiment of the invention;

FIG. 1B is a partial longitudinal cross-sectional view of the container of FIG. 1A;

FIG. 2 is a schematic diagram illustrating how the tabs at one end of the tubular member are folded over a convex section of a tip to form an end of a container in accordance with a particular variant of the first embodiment of the invention;

FIG. 3 is a schematic diagram illustrating how the tabs at one end of the tubular member are folded over a conical section of a tip to form an end of a container in accordance with a second particular variant of the first embodiment of the invention;

FIG. 4 is a schematic, perspective illustration of an apparatus allowing the continuous production of the tubular member of the container of the invention;

FIGS. 5A and 5B are schematic, perspective illustrations of the step of circumferential winding to form the circumferential layer of a container in accordance with the second variant of the first embodiment of the invention;

FIG. 6 is a partial perspective view showing a middle section of a container in accordance with a first variant of second embodiment of the invention;

FIG. 7 is a partial, longitudinal cross-sectional view of the container of FIG. 6 at an inner ring provided to receive a pressure relief device;

FIGS. 8A and 8B are partial, longitudinal cross-sectional views, similar to FIG. 7, but showing a container in accordance with a second variant of the second embodiment of the invention.

10

### DETAILED DESCRIPTION OF EMBODIMENTS

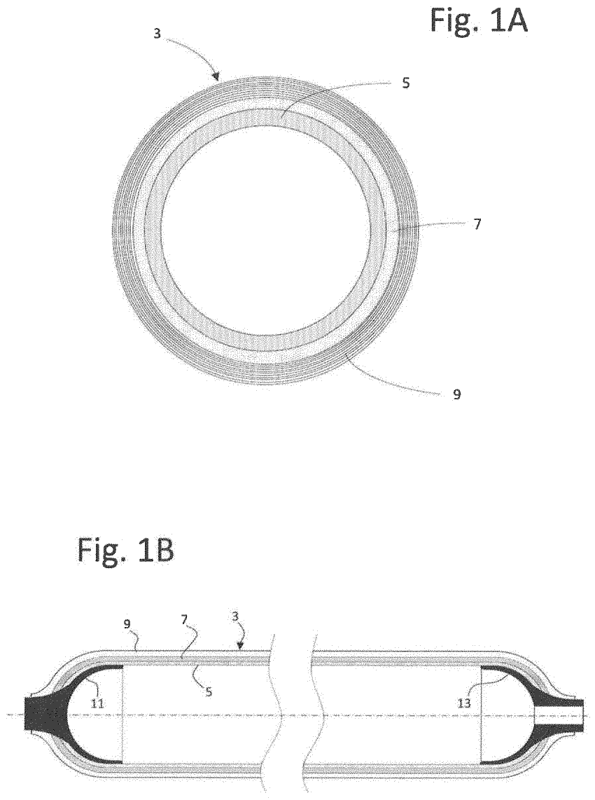

FIG. 1A is a transverse cross-sectional view of a container made of composite material in accordance with a first embodiment of the invention. It can be seen that the composite wall 3 of the container has a circular cross-section. This wall 3 firstly comprises a multilayer tubular member formed of a plastic tube 5 coated with a first layer 7 of composite material. One function of the tube 5 is to ensure good sealing tightness with respect to the fluid contained in the container. To this end, in the present example, the tube 5 is formed of thermoplastic material. Advantageously, the resin used in the composite material forming the layer 7 can likewise be thermoplastic material. In accordance with a preferred variant of the invention, the layer 7 is formed of carbon fibres embedded in a thermoplastic matrix. The carbon fibres are in parallel with each other and are oriented in the direction of the longitudinal axis of the container. Therefore, the layer 7 of composite material will be referred to as the longitudinal layer hereinafter. The multilayer tubular member is itself surrounded by a second layer of composite material 9, referred to as the circumferential layer 9 hereinafter. This layer is formed of carbon fibres wound in parallel with each other around the tubular member. The fibres of the layer 9 are wound circumferentially or, in other words, substantially perpendicularly to the axis of the container. They are likewise embedded in a thermoplastic matrix. It will be understood from the preceding text that the wall 3 of the container illustrated in FIG. 1A is formed of three layers. However, in accordance with other embodiments, the container of the invention can have a greater number of layers. In particular, the container of the invention can comprise an additional composite layer, e.g. of glass fibres, used as an outer protection layer.

FIG. 1B is a partial longitudinal cross-sectional view of the container of FIG. 1A. This container can have a considerable length. In fact, as will be seen in more detail hereinafter, some advantages of the present invention prove to be more and more useful, the longer the container is relative to its diameter. Owing to the considerable length of the container of the present example, the partial view of FIG. 1B shows only the two ends with a cut therebetween. It can be seen that each end of the container has a tip 11, 13. This tip is preferably metal, e.g. made of an aluminium alloy. In the illustrated example, the two tips are each in the shape of a pointed dome and are each inserted coaxially into an end of the multilayer tubular member. The convex outer surface of each nose cone-shaped tip is oriented towards the outside of the container. FIG. 1B also shows that one of the tips has a small central opening provided for the pressurised fluid. The other tip, which does not have an opening, forms the bottom of the container. Finally, FIGS. 1A and 1B also show that the composite wall 3 is generally in the shape of a cylinder which extends axially between the two tips 11, 13.

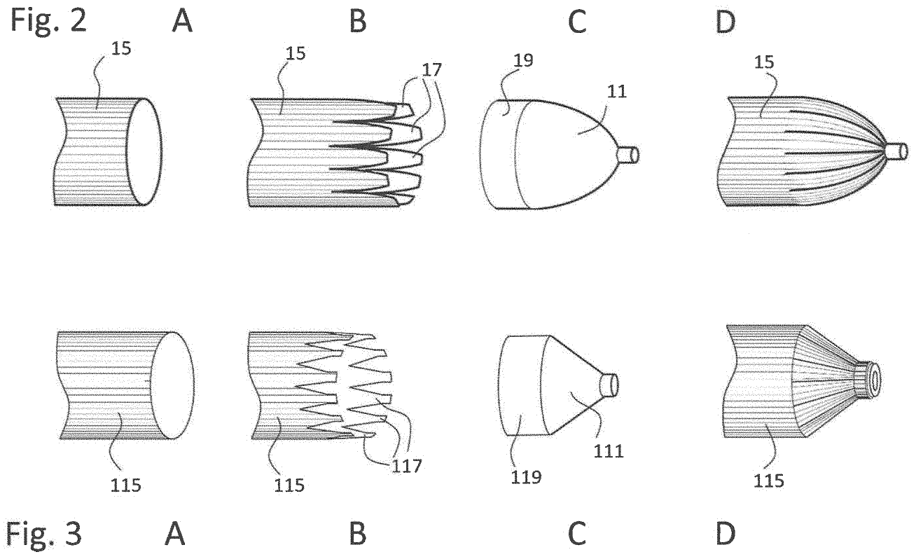

In accordance with the invention, the profile of the wall 3 has a narrowing at each of its ends such that the wall comes to be placed against a convex portion of the outer surface of each of the tips. By way of example, FIGS. 2 and 3 illustrate one possible manner of providing such a configuration to the ends of a container in accordance with the invention. As shown in these two figures, the ends of the wall of the tubular member 15 can each be provided with a row of tabs (which are designated by reference numerals 17 and 117 in FIGS. 2 and 3 respectively). When producing the container, once one of the tips is inserted into the corresponding denticulate end of the tubular member 15, the tabs are folded over the convex outer surface of the tip so as to form a tapered end.

It is essentially the shape of the tip which distinguishes the members shown in FIG. 3 from those shown in FIG. 2. Referring more particularly to FIG. 2, it can be seen that the illustrated tip (reference numeral 11) is in the general shape of a pointed dome and that it is provided with a central opening in accordance with what has already been described in relation to FIG. 1B. It can also be seen that the tip 11 likewise has a cylindrical portion 19 which extends the edge of the nose cone towards the interior of the container. FIG. 2 also shows that the tabs 17 at the end of the wall of the tubular member 15 have rounded edges. It will be understood that the rounded shape of the tabs is a result of the domed shape of the outer wall of the tip 11.

In fact, the shape of the tabs is selected to allow, on the one hand, them to be folded against the convex outer surface of the tip 11 without overlapping and, on the other hand, such that the folded tabs preferably cover the convex surface without leaving any uncovered gaps.

Referring now to FIG. 3, it can be seen that the illustrated tip (reference numeral 111) is in the general shape of a cone provided with a central opening. As in the previous example, the tip 111 also has a cylindrical portion 119 which extends the edge of the cone towards the interior of the container. FIG. 3 also shows that the tabs 117 at the end of the wall of the tubular member 15 are in the form of isosceles trapeziums or triangles. Again, the triangular shape of the tabs is a result of the shape of the outer wall of the tip 111. In fact, the shape of the tabs is selected to allow, on the one hand, them to be folded against the conical outer surface of the tip 111 without overlapping and, on the other hand, such that the folded tabs preferably cover the conical surface without leaving any uncovered gaps. However, it will be understood that, in accordance with other embodiments, not shown, of the invention, the tabs could overlap or, conversely, leave large uncovered spaces between two tabs. FIGS. 2 and 3 will be discussed again hereinafter in relation to an inventive method for forming the container of the invention.

Referring again to FIG. 1B, it will be understood that the internal pressure of the container tends to repel the tips 11, 13 axially towards the outside of the container. Under these conditions, the peripheral part of the outer surface of each of the tips 11, 13 comes to be wedged against one of the end narrowings of the wall 3 of the container. In order to ensure the rigidity of the structure, means are preferably provided to ensure that the tabs 17, 117 adhere to the convex outer surface of each of the tips 11, 13. Moreover, in order to ensure the sealing tightness of the join between the tubular member 15 and the two tips, means are likewise preferably provided to ensure that the inner wall of the tubular member 15 adheres to the circumference of the cylindrical part 19, 119 of each tip.

As has already been mentioned, the inner layer 5 of the tubular member 15 of the container illustrated in FIGS. 1A and 1B is formed of a thermoplastic tube 5. One advantage of thermoplastic resins compared with thermosetting resins is that as they age, thermoplastic liners retain their sealing tightness for longer. In fact, thermoplastic materials are normally more elastic than thermoset resins and they are thus more resistant to the numerous pressurisation/depressurisation cycles which punctuate the lifetime of a container.

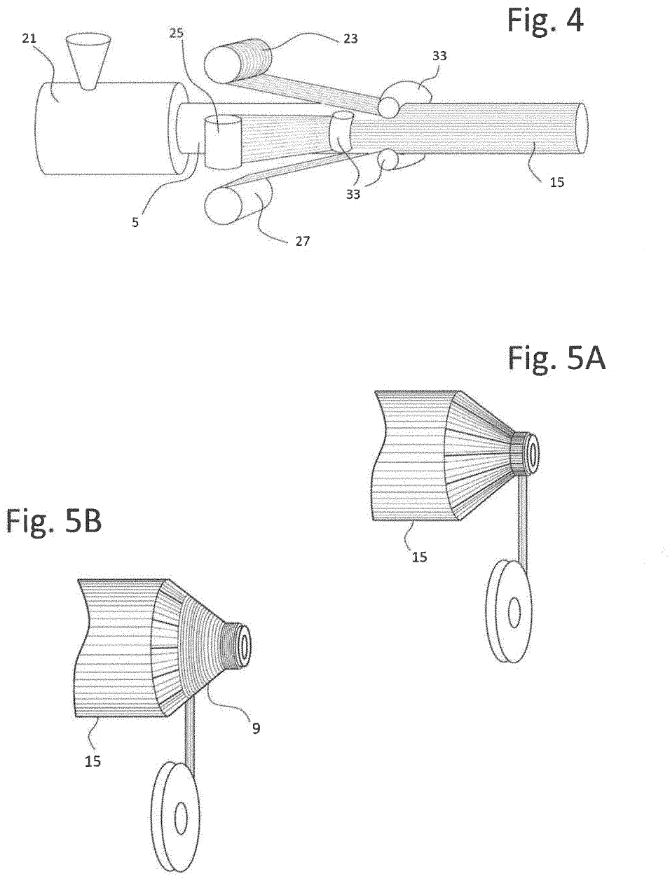

FIGS. 3 to 5B illustrate different steps of a method for producing a container in accordance with the invention. Firstly, FIG. 4 illustrates one particular manner of implementing the first steps of the method of the invention. In FIG. 4, an extruder (reference numeral 21) can firstly be seen which is arranged to produce the profiled tube 5 and which is associated with four reels arranged, respectively, above, below, behind and in front of the longitudinal axis of the profiled tube 5. Three reels (designated respectively with reference numerals 23, 25 and 27) are visible in FIG. 4 and it will be understood that the fourth reel, which is located behind the arrangement, is hidden. It can also be seen in FIG. 4 that a roller (reference numeral 33) is associated with each of the reels.

Each reel is essentially formed of a wide spool on which a large number of parallel fibres are wound. As shown in FIG. 4, the parallel fibres are coiled so as to form a flat bundle when they are unrolled together from the reel. The flat bundle has a constant width and a small thickness. In the illustrated example, the width of the flat bundles from each of the reels 23, 25, 27 is almost equal to the diameter of the plastic tube. Under these conditions, a single flat bundle is sufficient to cover about one quarter of the circumference of the tube 5. This is the reason why the arrangement in FIG. 4 only has four reels. However, it will be understood that it is also possible to use reels providing narrower flat bundles. Of course, in that case, the number of reels arranged around the longitudinal axis of the profiled tube 5 will have to be greater than four.

In accordance with the invention, the tubular member 15 is formed of a profiled plastic tube 5 covered with straight fibres oriented in the longitudinal direction of the profiled tube. FIG. 4 illustrates the production of a tubular member in accordance with one particular embodiment of the method of the invention. To this end, the arrangement in FIG. 4 firstly allows the production, by extrusion, of the profiled plastic tube 5 and also allows the placement at the same time of the rows of towpregs or strips of pre-impregnated fibres on the outer wall of the tube 5 to form the longitudinal layer 7.

Referring still to FIG. 4, it can be seen how the rollers 33 of the illustrated arrangement allow the guiding and pressing of the flat bundles of fibres against the outer wall of the tube 5 such that they fully cover the wall as the profiled tube is advanced out of the extruder 21. It has already been mentioned above that, in accordance with a preferred variant of the invention, the fibres forming the longitudinal layer 7 are impregnated with a thermoplastic resin. The resin must thus be heated to be able to be worked. Consequently, in the case where the fibres are impregnated with a thermoplastic resin, the arrangement of FIG. 4 also comprises a heating device (not shown) to bring the meeting zone between the surface of the tube and fibres to a temperature close to the resin melting temperature so as to ensure good welding of the fibres on the tube 5.

In the case where the resin used is a thermosetting resin, the longitudinal layer 7 can generally be cold-formed. It should once again be noted that the invention is not limited to the use of pre-impregnated fibres. In fact, in a manner known per se, there are two other main categories of methods for applying resin-impregnated fibres. A first category known under the name “wet winding method” consists of impregnating the fibres with liquid resin just before they are placed on the surface to be covered. This result can be obtained for example by passing the fibres into a bath interposed between the reels and the plastic tube to be coated. The other method is known under the name “dry winding method”. In this case, resin impregnation occurs subsequently.

The tubular member 15 produced by the arrangement of FIG. 4 must then be cut into sections of the desired length to form the container of the invention. Once the tubular member 15 has been formed, the following step consists of assembling this member and the two end tips 11, 13. In accordance with the particular embodiment illustrated in FIGS. 2 and 3, equidistant notches are firstly cut into the end of the wall of the tubular member, so as to form a crown of tabs. Every two neighbouring tabs are thus separated by a notch and, as can be seen in particular in FIGS. 2B and 3B, the notches are tapered and are oriented in parallel in the direction of the longitudinal axis of the tubular member. Owing to this feature, the straight fibres of the longitudinal layer 7 of the tubular member extend to the end of each tab in parallel with the longitudinal axis of the tabs. This arrangement provides the tabs with greater tensile strength in the longitudinal direction. In accordance with the invention, there can be any number of tabs. However, in order to limit the amount of work, and thus the cost, the number of tabs should be kept to a minimum. In contrast, too few tabs results in the appearance of undesirable facets close to the ends of the container. Therefore, the number of tabs must not be too low. By way of example, the toothing formed in FIG. 2 has 10 tabs.

Once the row of tabs has been produced, a tip 11, 13 is placed within each of the ends of the tubular member 15. It will be understood that the diameter of the cylindrical part 19 or 119 of the tips is selected such that the dimension of the tips is well adapted to that of the circular openings in the tubular member 15 such that the axes of the tips are well aligned with the longitudinal axis of the tubular member 15. The tips are preferably positioned axially such that the boundary between their cylindrical portion and their convex portion is located approximately opposite the end of the tapered notches separating the tabs. Once the tips 11, 13 have been positioned in the ends of the tubular member 15, the tabs 17 or 117 are folded against the outer surface of the convex part of the tips such that an assembly similar to that illustrated in FIG. 2D or that illustrated in FIG. 3D is obtained.

To facilitate this latter step, the tabs can be heated so as to soften the thermoplastic resin. To ensure good adhesion of the tips with the inner surface of the tubular member 15, as well as with the tabs 17 or 117, the outer surface of the tips can be subjected to prior treatment. This surface treatment can be, for example, flame treatment, plasma treatment, chemical treatment, mechanical treatment, etc.

In the case of metal tips, instead of performing surface treatment in accordance with an advantageous variant of the invention, a thermoplastic layer (not shown) is over-moulded on each of the metal tips. Moreover, the thermoplastic material which is over-moulded on the tips is preferably of the same type as the thermoplastic material forming the plastic tube 5. It can be, for example, PE, PP, PET, PA, PVDF or PPS. This feature has the advantage of allowing secure welding of the inner wall of the tubular member and the tabs to the outer wall of the tips simply by heating. Moreover, during the welding step, the notches between the tabs close up and the tabs are also welded together. It will be understood that, in order to guarantee good sealing-tightness of the container, the welding step is preferably not limited to welding the tabs to the convex part of the tips, but likewise consists of welding a portion of the inner wall of the cylindrical member to the cylindrical part 19 or 119 of the tips.

Once the tips 11, 13 and the tubular member 15 have been assembled and welded, the following step consists of circumferentially winding resin-impregnated fibres around the tubular member 15 and the tips 11 and 13 to form the circumferential layer 9 of the container. FIGS. 5A and 5B are schematic illustrations which show the principle of circumferential winding. In the illustrated example, a flat bundle of towpregs or strips of fibres are circumferentially wound, starting at the end of one of the tips and progressively moving along the container so as to completely cover it. Referring still to FIGS. 5A and 5B, it will be understood that when the towpreg or fibre strips are wound around the part of the tip which becomes thinner towards the outside, the width of the towpreg or fibre strips must be small enough that the towpreg or fibre strips can adapt to the variation of the circumference of the tip between one edge and the other of the towpreg or a fibre strip. In accordance with the invention, the thus formed circumferential layer 9 comprises at least one layer of circumferentially wound fibres. However, advantageously, the layer 9 can comprise a plurality of layers of circumferentially wound fibres. Thus, once the container has been completely covered with a first layer of circumferentially wound fibres, at least one second layer can preferably be wound over the first layer.

As already mentioned in relation to FIG. 1B, the internal pressure of the container tends to repel the tips 11, 13 axially towards the outside of the container. The pressure thus likewise tends to space apart the tabs which have been folded against the outer surface of the tips. Under these conditions, the fibres wound circumferentially around the tubular member 15 make it possible to ensure that the tabs do not become separated from each other and from the tips. In fact, the circumferential fibres which surround the tips keep the tabs placed against the outer surface of said tips.

In accordance with one particular embodiment variant of the method of the invention, once the circumferential layer has been formed, the container filled with pressurised fluid is placed in a backing mould and heated so as to homogenise each of the layers 5, 7 and 9 and bind them together.

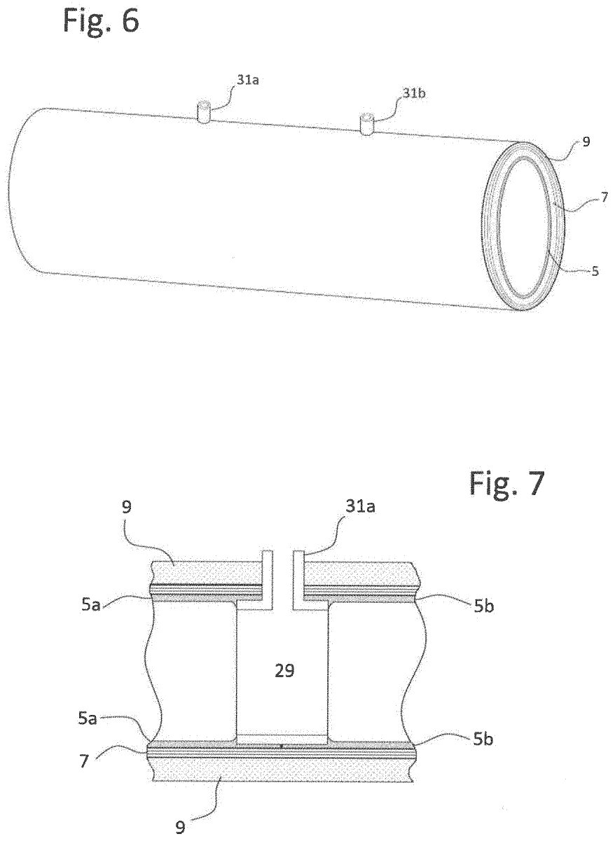

FIGS. 6 and 7 relate to a long container which corresponds to a first variant of a second embodiment of the invention. The container shown in FIGS. 6 and 7 has the feature of having inner rings each provided with a protruding conduit which has an orifice passing therethrough, said orifice communicating with the outside. This conduit is provided to receive a pressure relief device. FIG. 6 is a partial perspective view which shows a middle section of a container which has two protruding conduits 31a, 31b for pressure relief devices.

FIG. 7 is a partial, sectional view of the container of FIG. 6 showing an inner ring 29 which supports the protruding conduit 31a. Disregarding the presence of the inner rings and the associated conduits, a container in accordance with the second embodiment of the invention can be identical to a container in accordance with the first embodiment. In accordance with what has been described with respect to the first embodiment, the wall of the container of FIGS. 6 and 7 is formed of three layers. These layers are an inner layer formed by a plastic tube 5, a first layer 7 of composite material called longitudinal layer, surrounding the tube 5 and formed of carbon fibres oriented in parallel with the longitudinal axis of the container, and finally a second layer of composite material called circumferential layer 9 formed of carbon fibres circumferentially wound around the layer 7. Referring more particularly to FIG. 7, it will be understood that in the first variant of the second embodiment, the layer 5 is, in fact, formed of the assembly of two plastic tubes 5a and 5b which are connected to each other, end-to-end, at the inner ring 29.

In a similar manner to what has been described above in relation to the tips 11, 13, the inner ring 29 can be subjected to prior surface treatment. Alternatively, in accordance with an advantageous variant of the invention, the inner ring 29 is not completely formed of metal. In fact, a layer (not shown) of the same thermoplastic material as the tubes 5a and 5b is preferably over-moulded on the outer wall of the ring. This feature has the advantage of making it possible to sealingly weld the inner wall of the tubes 5a and 5b to the outer wall of the ring 21. In accordance with this first variant of the second embodiment of the invention, the tubes 5a and 5b are coated with fibres oriented on the longitudinal axis of the container, so as to form the longitudinal layer, preferably only once these tubes have been connected using the inner ring 29. It will be understood that the conduits 31a and 31b form obstacles during placement of the longitudinal fibres. However, these obstacles have limited dimensions and it is possible to bypass them without the fibres deviating significantly from their path.

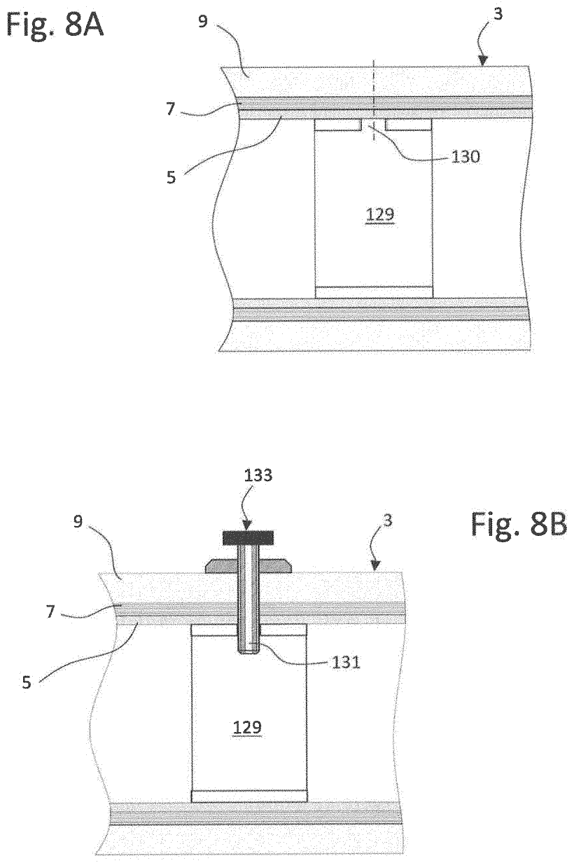

FIGS. 8A and 8B are partial, longitudinal cross-sectional views, similar to FIG. 7, but showing a container in accordance with a second variant of the second embodiment of the invention. Referring firstly to FIG. 8A, it can be seen that, contrary to what is shown in FIG. 7, the inner ring 129 of FIG. 8A does not have a conduit protruding to the outside of the container. In fact, in accordance with this second variant, the ring 129 has a threaded hole 130 in place of the conduit of the first variant. It will be understood that, since the outer wall of the inner ring 129 is free of protruding parts, it is possible to insert it into the plastic tube 5 through one of its ends.

FIG. 8B is a partial, transverse cross-sectional view similar to FIG. 8A but showing the finished container fitted with a pressure relief device 133. To move from FIG. 8A to FIG. 8B, the following steps can be performed. Once the longitudinal layer 7 and the circumferential layer 9 of the container have been formed, an opening is formed through the wall of the container so as to provide access to the threaded hole 130 of the inner ring 129. Then, a conduit 131 with a short length is inserted into the opening such that the conduit protrudes outside of the container. In the present example, one of the ends of the conduit 131 is threaded so as to allow the conduit to be screwed into the hole 130 of the inner ring. The pressure relief device 133 is then fixed to the conduit 131 and to the wall of the container by proceeding in the same manner as for the first variant shown in FIGS. 6 and 7.

It will also be understood that various modifications and/or improvements obvious to a person skilled in the art can be made to the embodiment being described herein without departing from the scope of the present invention defined by the accompanying claims.

1. A method for forming a container made of composite material, the method comprising the steps of:
(a) providing a profiled, plastic tube (5);
(b) covering the outer wall of the plastic tube (5) with parallel, resin-impregnated fibres, the parallel fibres being straight and oriented in a longitudinal direction of the profiled, plastic tube to form a tubular member (15) having a wall with ends;
(c) inserting two tips (11, 13; 111) respectively into the ends of the tubular member (15), the two tips terminating at outside ends;
(d) deforming the wall at each of the ends of the tubular member (15) so as to shape the ends of the tubular member to match a shape of the two tips (11, 13; 111); and
(e) circumferentially winding the resin-impregnated fibres around the tubular member (15) and the two tips (11, 13; 111) to form a circumferential layer (9) of the container, with the circumferential layer surrounding the tubular member and the two tips.

2. The method according to claim 1 for forming a container made of composite material,
wherein the method is implemented on an extrusion production line comprising an extruder (21) and a plurality of reels (23, 25, 27) arranged to unwind, in parallel, towpregs or strips of resin-impregnated fibres, wherein step (a) of providing a profiled, plastic tube (5) is performed by producing said profiled, plastic tube by extrusion, and
wherein step (b) of covering the outer wall of the profiled, plastic tube (5) with parallel, resin-impregnated fibres is performed by attaching the towpregs or strips of fibres drawn from the reels to the outer wall of the profiled, plastic tube (5).

3. The method according to claim 2 for forming a container made of composite material, wherein step (a) of providing a profiled, plastic tube (5) is performed by producing said profiled, plastic tube by extrusion, and step (b) of covering the outer wall of the plastic tube (5) with parallel, resin-impregnated fibres are implemented in-line.

4. The method according to claim 1, further comprising, between step (b) of covering the outer wall of the plastic tube (5) with parallel, resin-impregnated fibres and step (c) of inserting two tips (11, 13) respectively into the ends of the tubular member (15), a step (b′) of cutting equidistant notches into an end of the wall of the tubular member (15) so as to form a crown of tabs (17; 117).

5. The method according to claim 1, wherein during step (a) of providing a profiled, plastic tube (5), there are provided at least two profiled, plastic tubes (5a, 5b), and wherein the method comprises, between step (a) of providing a profiled, plastic tube (5) is performed by producing said profiled, plastic tube by extrusion, and wherein step (b) of covering the outer wall of the plastic tube (5) with parallel, resin-impregnated fibres, a step (a′) comprising connecting the two profiled tubes together, end-to-end, using an inner ring (29) provided with a protruding conduit (31a, 31b).

6. The method according to claim 1, further comprising, before step (c) of inserting two tips (11, 13) respectively into the ends of the tubular member (15), a step (b″) includes inserting an inner ring (129) comprising a piercing (130) within the profiled tube (5) through one of the ends, and wherein, after step (e) of circumferentially winding the resin-impregnated fibres around the tubular member (15) and the two tips (11, 13; 111) to form a circumferential layer (9) of the container, a step of first providing an opening through the wall (3) of the container so as to provide access to the piercing (130) and then inserting a conduit (131) into the opening so that the conduit protrudes out of the container.

7. The method according to claim 1, wherein after step (e) of circumferentially winding the resin-impregnated fibres around the tubular member (15) and the two tips (11, 13; 111) to form a circumferential layer (9) of the container,
a tapered section at least of each of the two tips (11, 13; 111) has a shape which tapers towards the outside ends,
wherein the wall of the tubular member (15) has a narrowing at each of the ends, such that, at each end, the wall is placed against an outer surface of the tapered section of each of the two tips, and
the wound fibers of the circumferential layer (9) are wound circumferentially around the tubular member (15), including tapered ends of the tubular member, and the two tips (11, 13) in parallel with each other, the wound fibers of the circumferential layer (9) having a path formed of a series of turns, each turn extending in a plane substantially perpendicular to an axis of the tubular member.

8. The method according to claim 4, wherein after step (b′) of cutting equidistant notches into an end of the wall of the tubular member (15) so as to form a crown of tabs (17; 117), the ends of the wall of the tubular member (15) are denticulate so as to each have a crown of tabs (17; 117), the tabs being folded against the tips (11, 13; 111) so as to form narrowings.

9. The method according to claim 1, wherein the tubular member (15) is formed with a cylindrical shape.

10. The method according to claim 1, wherein the two tips (11, 13; 111) are formed of metal.

11. The method according to claim 1, wherein the two tips (11, 13; 111) are formed of a composite material.

12. The method according to claim 1, wherein each of the two tips (111) are formed with a conical shape.

13. The method according to claim 7, wherein a shape of said tapered section of each of the two tips (11, 13) is formed to be convex.

14. The method according to claim 7, wherein a shape of said tapered section of each of the two tips (11, 13) is formed to a paraboloid.

15. The method according to claim 1, wherein each of the two tips (11, 13; 111) has a tubular portion (19; 119) having a cross-section complementary to a transverse cross-section of the tubular member, the tubular portion extending the tip towards an inside of the container, from the tapered section.

16. The method according to claim 5, wherein the inner ring (29) associated with a protruding conduit (31a, 31b; 131) extends out of the container, and is adapted to receive a pressure relief device (133).
